(19) United States
(12) Patent Application Publication
(10) Pub. No.: US 2024/0112160 A1
(43) Pub. Date: Apr. 4, 2024

(54) TOKEN BASED SYSTEM FOR VALUE TRANSFERS

(71) Applicant: Visa International Service Association, San Francisco, CA (US)

(72) Inventors: Minghua Xu, Austin, TX (US); Shan Jin, Austin, TX (US)

(73) Assignee: Visa International Service Association, San Francisco, CA (US)

(21) Appl. No.: 18/264,900

(22) PCT Filed: Feb. 17, 2022
(86) PCT No.: PCT/US2022/016876

§ 371 Date: Aug. 9, 2023

Related U.S. Application Data
(60) Provisional application No. 63/150,971, filed on Feb. 18, 2021.

(51) Int. Cl. G06Q 20/10; G06Q 20/36; G06Q 20/38; G06Q 20/40

(52) U.S. Cl. CPC G06Q 20/10; G06Q 20/3672; G06Q 20/3825; G06Q 20/4014; G06Q 2220/00

(57) ABSTRACT

A method is disclosed. The method comprises generating, by sender device or a sender computer associated with a sender, a base token in a token space associated with parameters. The base token can comprise one or more token attributes within the parameters, and an amount. The base token can then be signed, by the sender device or the sender computer, to form a minted token. The method may then include transmitting, by the sender device to a receiver device, a transfer request comprising the minted token.

### CROSS-REFERENCES TO RELATED APPLICATIONS

This application is a PCT application, which claims priority to and the benefit of U.S. Provisional Patent Application No. 63/150,971, filed on Feb. 18, 2021 which is herein incorporated by reference.

### BACKGROUND

Conducting value transfers between entities can be complex and can take time.

Traditional banking systems are usually treated as heterogeneous distributed systems. The movement of money from a source bank to a destination bank is best performed using the shortest path between them. First, consider the situation in which there are only two nodes conducting a transaction. The transaction starts with a user A initiating transaction to pay user B amount x electronically and remotely. User A will request his home bank A to perform a ledger transaction, which is inserted into a send transaction message. Bank A, will in turn, send all pending transactions to a hub for clearing and settlement. Assuming user B's home bank B is associated with the hub, the hub will insert the target transaction into a receive transaction message to bank B. Bank B then provides the payment to user B.

In most cases, especially in the case of cross-border transactions, multiple nodes are used to move money. That is, it is not often the case that a sender bank and a receiver bank use the same hub. They can often use different hubs, and there can be many intermediate banks between the hubs of the receiver and sender banks. This can result in slow transactions and can also result in errors as payment transactions can traverse many nodes before reaching their final destinations.

One way to address these issues is to use cryptocurrencies such as Bitcoin to conduct transfers. However, several problems exist with respect to conventional cryptocurrency transactions. For example, conventional cryptocurrency transactions such as Bitcoin cannot be conducted offline. If a conventional cryptocurrency such as Bitcoin could be used to conduct offline transactions, then this would lead to problems of potential double spending. Further, conventional cryptocurrency transactions such as Bitcoin are not strictly tied to fiat currencies, and therefore are less likely to be accepted and universally used.

Embodiments of the disclosure address this problem and other problems individually and collectively.

### BRIEF SUMMARY

One embodiment includes a method. The method comprises: generating, by sender device or a sender computer associated with a sender, a base token in a token space associated with parameters, wherein the base token comprises token attributes within the parameters and an amount; signing, by the sender device or the sender computer, the base token to form a minted token; and transmitting, by the sender device to a receiver device, a transfer request comprising the minted token.

Another embodiment includes a device comprising: a processor; and a non-transitory computer readable medium comprising instructions executable by the processor to perform operations including: generating a base token in a token space associated with parameters, wherein the base token comprises token attributes within the parameters and an amount; signing the base token to form a minted token; and transmitting, to a receiver device, a transfer request comprising the minted token.

Another embodiment includes another method. The method comprises: receiving, by a receiver device associated with a receiver from a sender device associated with a sender, a transfer request comprising a minted token in a token space associated with parameters, wherein the minted token comprises token attributes contained within the parameters; verifying, by the receiver device, the minted token by checking that token attributes of the minted token are within the parameters of the token space; modifying, by the receiver device, a status of the minted token to form a modified token; and signing, by the receiver device, the modified token to form a cleared token.

A better understanding of the nature and advantages of embodiments of the present invention may be gained with reference to the following detailed description and accompanying drawings.

### BRIEF DESCRIPTION OF THE DRAWINGS

FIG. 1 shows a block diagram of a distributed and hierarchical trusted token-based digital currency system according to embodiments.

FIG. 2A shows a block diagram illustrating the lifecycle of a token according to embodiments.

FIG. 2B shows a block diagram illustrating a system of ledgers according to embodiments.

FIG. 3 shows an illustration of a three-dimensional subspace model according to embodiments.

FIG. 4 shows a block diagram of a sender device and a receiver device communicating using three token subspaces according to embodiments.

FIG. 5 shows a block diagram illustrating a sender device and a receiver device communicating through a plurality of token subspaces according to embodiments.

FIG. 6 shows a block diagram of a partition model.

FIG. 7 shows a block diagram illustrating a plurality of users communicating through a plurality of token subspaces and a subspace partition according to embodiments.

FIG. 8 shows a flow diagram for a sender computer establishing a token space according to embodiments.

FIG. 9 shows a flow diagram for an online minting and clearing flow according to embodiments.

FIG. 10 shows a flow diagram for an offline minting and clearing flow according to embodiments.

FIG. 11 shows a block diagram of a user device according to embodiments.

FIG. 12 shows a block diagram of an authorizing entity computer according to embodiments.

### DETAILED DESCRIPTION

Prior to discussing embodiments of the disclosure, some terms can be described in further detail.

A “user” may include an individual. In some embodiments, a user may be associated with one or more personal accounts and/or mobile devices. In some embodiments, a user may be a sender or a receiver.

A “user device” may be a device that is operated by a user. Examples of user devices may include a mobile phone, a smart phone, a card, a personal digital assistant (PDA), a laptop computer, a desktop computer, a server computer, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. In some embodiments, a user device may be referred to as a sender device, or a receiver device.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or Xscale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “token” may be a data structure that holds value. The token may be a data structure that holds an amount of digital currency and is described by several token attributes and auditing information. “Token attributes” describe various properties of the token. Examples of token attributes include: value, sender identifier, receiver identifier, time-to-live, etc. For example, a “value” may describe the amount of digital currency in the token, and a “time-to-live” may describe a lifetime of the token.

“Auditing information” is information that can be used to audit the token. Auditing information can be used to track the life of a token. Examples of auditing information include: sender identifier, receiver identifier, source ledger address (e.g., an account number, a public key representing an account, etc.), destination ledger address, clearing party identifier, timestamp, etc. The auditing information of a token can be used to track the life of a token. For example, the minting party identifier and the timestamp identify who minted the token and when it was created, and the sender identifier and the receiver identifier may be used to track the movement of the token.

A “token space” can be a space that contains tokens. A token space may be divided using a set of parameters. The set of parameters may limit the tokens that can be in the token space and may form a “token subspace.” A token subspace can encompass a collection of tokens with one or more attributes which satisfy one or more parameters. For example, a set of parameters may include “value less than 100,” “sender identifier=1111,” and “time-to-live less than 10 seconds.” The resultant division of the token space can create a token subspace which can include tokens who have a value of less than 100, and a time-to-live less than 10 seconds that are sent by the sender identifier by “1111.” Token spaces and token subspaces may be implemented using a blockchain or a conventional database.

A “ledger” may be a record of accounts. Examples of ledgers can include local ledgers, source ledgers, destination ledgers, etc. A “local ledger” may be ledger that is proximate to a user (e.g., on a user device operated by a user, instead of in the cloud). A “source ledger” may be an account of a user that provides a source of funds. A “source ledger” could be a “local ledger” or it could be a ledger that is managed by a server computer. Examples of a source ledger can include a bank account, credit account, etc. A “destination ledger” can include a ledger that is intended to receive value (e.g., funds, token, etc.) from a source.

“Minting” can include the creation of currency. A minting algorithm may include creating a base token in a token space, adding value from a source ledger to the base token, setting token attributes, setting a status of the base token to “minted,” and digitally signing the base token to form a minted token. The minted token may be published to a ledger, so that the ledger contains the newly minted token. A “minted token” holds value originating from a source ledger. For example, the source ledger may contain USD, and the minted token may contain USDC. A minted token may be used in a transaction, where transmitting the minted token to a receiver results in transmitting the value of the token to the receiver.

“Clearing” can include the process of clearing a token. A clearing algorithm may include depositing value from a minted token to a destination ledger, changing a status of the minted token from “minted” to “cleared,” for example, by changing a bit or flag in the minted token itself to form a modified token, and then signing the resultant modified token to form a “cleared token.” As a part of the clearing algorithm, the cleared token may be published to a ledger, so that the ledger contains the newly cleared token.

Digital currency is a form of currency that exists in digital or electronic form. Due to its low cost, highly availability, and consistency, digital currency plays broad roles in digital payment and digital banking initiatives.

Normally, digital currency can be distinguished between decentralized and centralized digital currencies. In a decentralized digital currency system (e.g., Bitcoin, Ethereum, etc.), the digital currency system is implemented under decentralized control, meaning that a central authority is not needed. In a centralized digital currency system, there is a central authority that controls the movement of digital currency in the digital currency system. Typically, the central authority is a monetary authority, which issues and regulates digital currency.

An additional classification can be made based on the form of verification needed when digital currency is exchanged. Digital currencies can be classified as token-based, or account-based digital currencies. To use an account-based digital currency, the identity of the payer needs to be verified. To use an token-based digital currency, the validity of the object used to pay needs to be validated.

One type of centralized digital currency is central bank digital currency (CBDC). In contrast to other types of cryptocurrencies, CBDC is controlled by a central authority such as a central bank. The movement of CBDC can be implemented on a distributed system similar to other existing blockchain digital currencies.

Many digital currencies are implemented in a distributed system, which is a digital currency system that comprises multiple components located on different computers that communicate and coordinate with each other to perform actions. In order to satisfy the performance requirements of digital currency, the distributed system is specifically designed. The distributed system design should support the integration of multiple heterogeneous systems. Additionally, the distributed system design should achieve high availability, which includes high uptime, low latency, and consistency. Another property of the distributed system design is the ability to prevent double spending of digital currency.

In a distributed system, a widely applied principle for analyzing the performance of the distributed system is the CAP theorem. Under the CAP theorem, any distributed system can have at most two of three desirable properties: consistency (e.g., every data read receives the most recent data write, or an error), availability (e.g., every data request gets a non-error response, without the guarantee that it has the most recent write), and partition tolerance (e.g., the distributed system continues to operate through communication failures that split the network into disjoint sub-networks). On an abstract level, double spending is a specific example of a violation of consistency in the distributed system.

A token-based digital currency system for preventing double spending is proposed. The proposed token-based digital currency system is built as a trusted network, where all parties in the system recognize tokens in the network and agree to rules of the network. Additionally, all parties in the system agree to exchange a valid token for fiat currency when requested, even though the token may be associated with a specific token space. For example, a token in a transaction may have attributes such as: (i) $1, (ii) to transaction recipient A, and (iii) conducted with device B, and may be in a token space that is set up for tokens that are (a) limited to a transaction amount less than $5, (b) limited to a transaction recipient A, and (c) limited to transactions conducted with a certain type of user device such as user device B. Although this token has certain restrictions that help to prevent double spending, it can still be exchanged by the recipient for $1 in conventional fiat currency via the recipient's financial institution. Thus, through this agreement, a token may act as a limited fiat currency.

In traditional systems, the exchange of fiat currency between two parties consists of several steps including an initial transaction, and a subsequent settlement, where funds are transferred from one account to another. In the token-based digital currency system, the token itself holds value (as it can be exchanged for a fiat currency) and is used in the transaction, thus subverting the need for a subsequent settlement. In embodiments of the invention, tokens are used to structurally isolate transfer requests in the network, which maximizes the independency of each party. Tokens can also decouple the operations of minting tokens and clearing tokens, such that they are independent from each other.

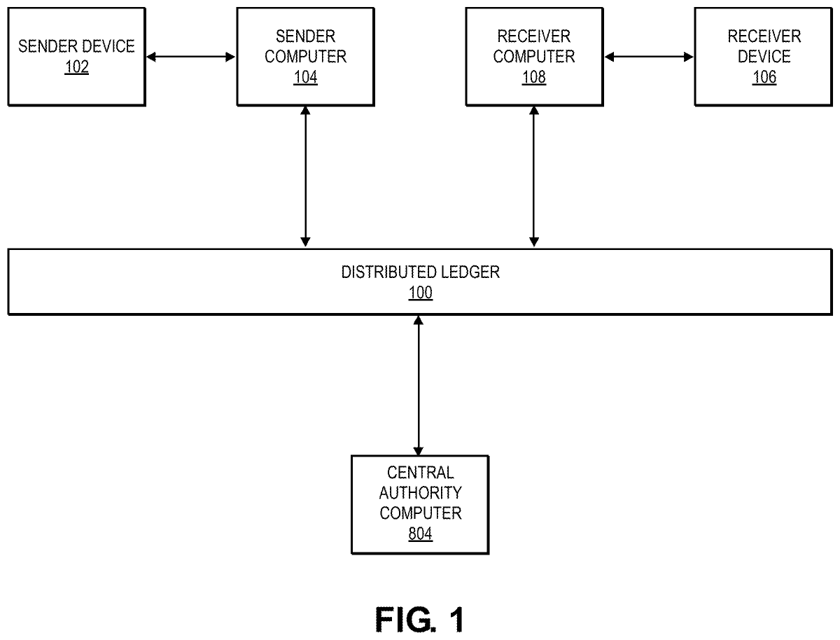

FIG. 1 shows a block diagram of a distributed and hierarchical trusted token-based digital currency system according to embodiments. The digital currency system is a token-based heterogeneous distributed system. A central authority (e.g., a central bank) operating a central authority computer 804 can maintain a distributed ledger 100. The central authority may determine entities that may issue digital currency accounts. For example, the central authority may determine that a sender computer 104 and a receiver computer 108 may issue digital currency accounts to users. The sender computer 104 may be a sender financial institution computer operated by an entity (e.g., an authorizing entity such as a bank) that issues a digital currency account to a sender operating a sender device 102 (e.g., a mobile phone, a laptop), or other senders. Similarly, the receiver computer 108 may be a receiver financial institution computer that is operated by an entity that issues a digital currency account a receiver operating a receiver device 106 (e.g., an access device, a computer, etc.), and other receivers.

The components in the token-based digital currency system of FIG. 1 and any of the following figures can be in operative communication with each other through any suitable communications medium. Suitable examples of the communications medium may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices of FIG. 1 may be transmitted using a secure communications protocol such as, but not limited to, File Transfer Protocol (FTP); HyperText Transfer Protocol (HTTP); and Secure Hypertext Transfer Protocol (HTTPS).

The token-based digital currency system according to embodiments of the invention can contain token APIs, such as token minting and token clearing APIs. Such APIs may reside between the distributed ledger 110 and/or the central authority computer 804, and the sender computer 104 and the receiver computer 108.

In the token-based digital currency system according to embodiments of the invention, the token can effectively decouple the distributed system, such that users may operate in an online or offline environment.

Exemplary principles of tokens in the token digital currency network according to embodiments of the invention can be as follows: all parties in the token-based digital currency system need to honor minted tokens, and perform cryptographic operations associated with the token; the minted token needs to be minted from an existing account; the minted token needs to be cleared with an existing account. Several variables and functions that used in the following description are summarized below in Table 1.

TABLE 1
Table of Variables and Functions

| Variable | Description |
|---|---|
| Aᵣ | Receiver's account |
| Aₛ | Sender's account |
| Cᵥ | A counter's value in Ω |
| Ω | A planned token space |
| Ωₐ | Set of attributes that plan the token space Ω |
| Qₕ | Hash queue in Ω |
| R | Auditing log record |
| T | A token |
| Tₐ | Attributes of the token |
| Tₕ | Hash value of a token's ID |
| T_{ID} | Token's ID |
| Tₛₙ | Token's state number in Ω |
| _{Tstate} | A state of a token that recorded in the Ω |
| | (= 1 when Minted and = 0 when Cleared) |
| Tₜₜₗ | Time-to-live of the token |
| Tᵥ | Value of the token |
| Aᵣ.deposit( ) | Deposit amount into Receiver's account |
| Aₛ.deduct( ) | Deduct amount from Sender's account |
| Hash ( ) | Output a cryptographic hash value |
| Load( ) | Check if the token is in Ω |
| R.publish( ) | Publish token to the auditing log record |
| Set( ) | Add token to Ω |
| Test Set( ) | Change token's state in Ω |
| T.init( ) | Initialize an empty token |
| Ω.add( ) | Add token into the token space Ω |

An exemplary token minting algorithm is described below. In the exemplary token minting algorithm there is a sender account, Aₛ, (e.g., the digital currency account associated with the sender device 102), which can be associated with sending a token. There can also be a receiver account, Aᵣ, (e.g., the digital currency account associated with the receiver device 106), which is associated with receiving the token. A token with value, v, is minted from the sender account, Aₛ, and sent to the receiver account, Aᵣ.

The token minting algorithm is summarized as follows:

Algorithm 1 Token Minting Algorithm

```
Begin DB Transfer request:
  Aₛ.deduct(v);
  T.init( );
  T.value=v;
  Set(T);
  R_{A}.publish(T);
End Transfer request with Commit
```

In the token minting algorithm, the value, v, is deducted from the sender account, Aₛ. After the value, v, is deducted, an empty token, T, is initialized. The empty token, T, could be a predetermined structured data file. The file may contain empty data fields for populating the token with data such as token attributes. After the empty token, T, is initialized, the value of the token is set to the value, v. The value of the token may be populated into one of the data fields of the file. At this point, other token attributes (e.g., a sender identifier, a receiver identifier, a timestamp, etc.) may be included in the token. In some embodiments, one or more of the data fields may contain a token identifier, which may be a unique value associated with the token. The token identifier may be a random value, a systematic value, or a deliberatively chosen value. Additionally, the state of the token, T_{State}, can be set to “minted” or “1.” Then, the token, T, is placed in a token space, Ω, through a token space operation, Set( ) which adds tokens into a planned token space. The token is then pushed to an auditing log for recording through a token space operation, R_{A}·publish(T). The publishing of token, T, to the auditing log serves as proof for checking the value, v, of the token, T, and value deducted from the sender account, Aₛ, are equal. The check can be performed when the token is published, or asynchronously.

An exemplary token clearing algorithm is described below. A token clearing process can be viewed as being the opposite of a token minting process. Clearing a token can put assets into a receiver account (e.g., a bank, credit, loan, or other account of the receiver).

Algorithm 2 Token Clearing Algorithm

```
Begin DB Transfer request:
  Aₜ.deposit(T.value);
  Test_Set(T);
  R_{A}.publish(T);
End Transfer request with Commit
```

In the clearing algorithm, the receiver account, Aᵣ, receives the value, v, from the token, T, using a token space operation, deposit( ). Then, the state of the token, T, is set to “cleared” by using a token space operation, Test_Set( ). In some embodiments, the state of the token, T, can be a variable in the token itself, or can be a variable in the token space where the token resides. For example, if the state is implemented in the token itself, the Test_Set( ) operation may change the status of the token by changing a variable in the token from a “1” which indicates a minted token, to “0,” which indicates a cleared token. In the next step, the cleared token, T, is published to the auditing log. Similar to the token minting algorithm, the auditing log can serve as proof for checking the value, v, of the token, T, and value deposited to the receiver account are equal. The check can be performed when the token is published, or asynchronously. The clearing algorithm may end with a commit operation, which can finalize a balance of the receiver account, Aᵣ.

After the state of the token, T, is set to “cleared”, the token, T, (or any clone of the token, T) no longer holds any value. With the token clearing algorithm and the token minting algorithm, digital currencies are moved between parties in the system. Any digital currency involved in the system is conserved throughout the exchange of tokens. In some embodiments, the movement of digital currencies through the token-based digital currency system does not create “new” value, nor “remove” any value in the system.

Aₛ noted in the token minting algorithm, a token minting operation is paired with a ledger operation to deduct value from a source. The source of token can be diverse in use cases of digital currency. Examples of sources can include personal banking accounts, personal loan accounts, business banking accounts, or decisions from central authorities to release new amounts or different amounts of currency into circulation.

After the token is minted, the minted token is not altered in any way. Aₛ the minted token is now a carrier of the value, it records information in transfer requests made in the token-based digital currency system. If the information of the token is allowed to change, then upholding the conservation of value in the token-based digital currency system may necessitate tracking all tokens in the system. Aₛ an example, Bitcoin blockchain is a typical system that allows infinite splitting of the “bitcoin” into many parts. The Bitcoin blockchain allows full freedom of mixing all parts of the bitcoin together. Aₛ a result, all parties in the bitcoin system are required to have access to a full copy of the bitcoin database. While Bitcoin is not a strictly token-based system, if tokens of the token-based digital currency system of FIG. 1 are allowed to be altered, a similar requirement would be needed for any party that receives a token.

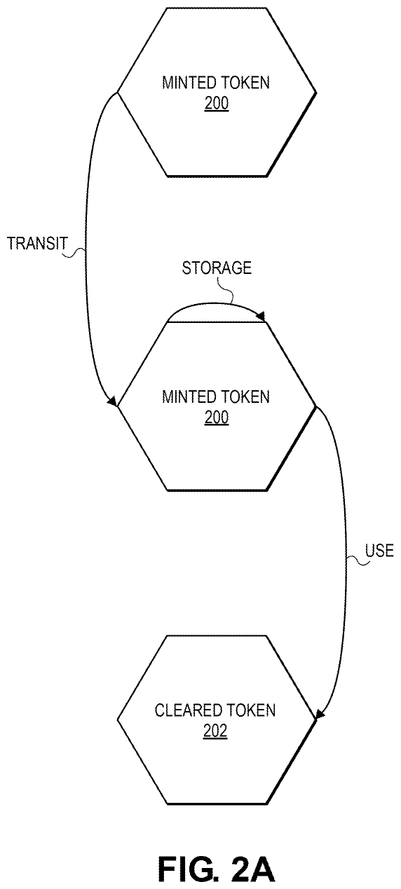

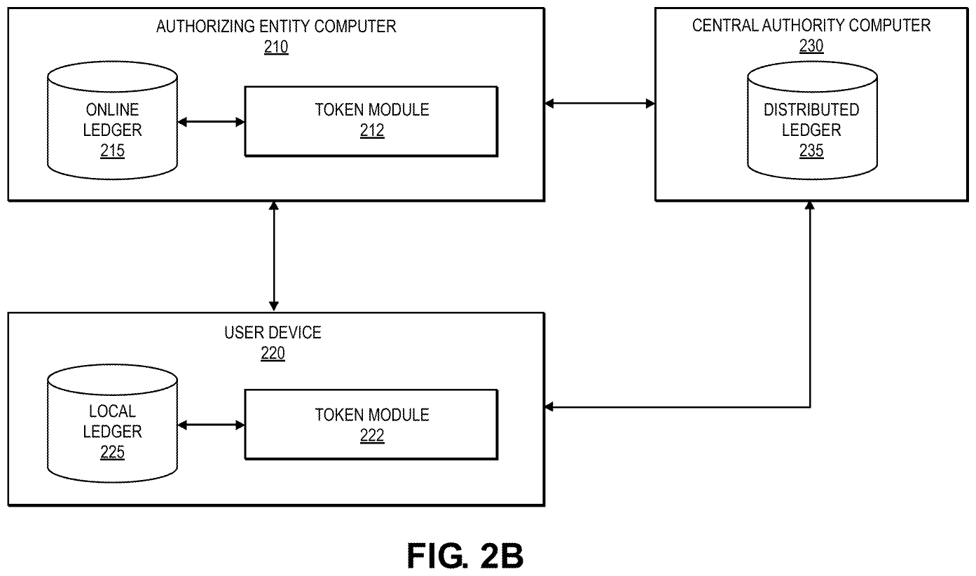

FIG. 2A shows a block diagram illustrating the lifecycle of a token according to embodiments. Once a token is minted, token attributes, which are immutability of properties of the token, simplify the lifecycle, or state transition, of the token. The token minting algorithm can be used to generate a minted token 200. Token attributes of the minted token 200 can include a value, a sender address, a time-to-live of the token, etc. After the minted token 200 is created, the minted token 200 can be temporarily in transit or storage. During this intermediate period, cryptographic protection provides immutability to the minted token 200. The token clearing algorithm may be used to transform the minted token 200 into a cleared token 202. For example, a sender may transmit a minted token 200 to a receiver to transfer value. The token clearing algorithm can allow the receiver to retrieve the value in the minted token 200 and transform the minted token 200 into the cleared token 202. Simplicity of the state transition (e.g., from “minted” to “cleared”) helps to design the token clearing algorithm with guaranteed consistency and high availability.

FIG. 2B shows a block diagram illustrating a system of ledgers according to embodiments. The system comprises an authorizing entity computer 210, a user device 220, and an central authority computer 230. The authorizing entity computer 210 may be a sender computer or a receiver computer. The user device 220 may be a sender device or a receiver device. The central authority computer 230 can maintain a distributed ledger 235 which may be a ledger that contains all tokens in a token space. The authorizing entity computer 210 may comprise an online ledger 215, which may contain a plurality of source ledgers (e.g., a plurality of bank accounts) of a plurality of users. The authorizing entity computer 210 may mint or clear tokens using a token module 212. The token module 212 may communicate with the online ledger 215 (e.g., to remove or deposit a value from an account balance of a user) to mint or clear tokens in token spaces. The user device 220 may comprise a local ledger 225. For example, the local ledger 225 may be an offline copy of the online ledger 215 that can be accessed by the user device 220 even if it is not connected to the authorizing entity computer 210. The user device 220 may mint or clear tokens using a token module 222. The token module 222 may communicate with the local ledger 225 to mint and clear tokens. The user device 220 may submit changes in the local ledger 225 to the authorizing entity computer 210, so that the changes can be included to the online ledger 215.

In many Internet tokens, self-destroy is often used as a mechanism. An internet token can have a time-to-live (TTL) as an attribute of the token. Any party handling the token can verify if the TTL is still valid (e.g., if the current time is in the range determined by the TTL). Cryptographic operations can be deployed to ensure that the TTL is original value that cannot be altered. For value movement, however, the destruction of tokens cannot rely upon the TTL of the token. In embodiments of the invention, a minted token can be invalidated once a receiver clears it through the token clearing algorithm. In an ideal situation, when a reliable and consistent global reachable storage is available, the destruction of tokens can be implemented by updating the status of token in the global storage. However, implementing a global storage with both consistency and availability is difficult due to CAP theorem.

The consistency requirement of movement of value in the token-based digital currency system is essentially equivalent to the “exactly once” in a real time messaging system. In real-time messaging systems, it is often desired to have an “exactly once” property. Instead, many systems choose to implement “at least once”, or “at most once” to balance consistency and availability in the real-time messaging system. In value movement, however, neither option (e.g., “at least once” or “at most once”) is acceptable. With respect to “at least once”, a token can be consumed or minted [1,2, . . . , n] times, in which “n such that n>1” times means that a single token is used or cleared multiple times, adding value to the system. With respect to “at most once”, a token can be consumed {0,1} times, where 0 means that the token is minted but never used and 1 means the token is cleared. With an auditing log (e.g., as introduced in the token minting and clearing algorithms), value is not lost, as it can be verified and tracked back to the source of the value (e.g., the sender account) and value can be recovered if the token is lost.

The root challenge for “exactly once” is caused by network partitioning in a heterogeneous distributed system. Per the CAP theorem, the challenge is fundamental in a distributed system. By partitioning the network pursuant to a planned scheme, it is possible to achieve high availability and strong consistency at the same time. Network partitioning can be performed by localizing parties involved in the movement of value, and by designing an approach to avoid a global storage (e.g., to transverse the tradeoff between consistency and availability).

In some cases, the movement of value is a localized activity. Many use cases in value movement occur between two parties, a sender and a receiver. A hub (e.g., an intermediate party) may be needed to connect the sender and the receiver. In token-based systems, the token itself plays role of the hub. Because of this, deciding the number of times that the token is cleared in the system is a localized operation performed by a particular receiver. If there is a guarantee that no other party can clear the same token in the system, then token clearing does not need global consensus. This guarantee can allow the receiver to manage a smaller set of tokens.

Tokens can be organized into token spaces. Token spaces can support several atomic operations including: Seto, which adds the token to the planned token space; Test_Set( ), which modifies the token's state in the token or the token space (e.g., from a value of “1” or “minted” to a value of “0” or “cleared”); and Load( ), which checks if the given token is in the planned token space. Example implementations of these three operations, is shown in the following pseudocode:

```
Boolean 2 Set(T)
  IF ( {∃a ∈ Tₐ} match with Ωₐ) && !Load(T)
    Ω.add(T);
    Test_Set(Tₛₜₐₜₑ);
    Tₛₙ = Cᵥ + 1;
    Return True;
  ELSE
    Return False;
Boolean Test Set(Tₛₜₐₜₑ):
    IF Tₛₜₐₜₑ ==Minted
      Tₛₜₐₜₑ =Cleared;
    Return Tₛₜₐₜₑ;
Token Load(T):
    Tₕ=Hash(T_{ID});
    IF Tₕ ∉ Qₕ
Return T;
    ELSE
Return NULL
```

To provide a guarantee that a token can only be cleared by a particular receiver in the token-based digital currency system, a definition and conjectures on token spaces are proposed.

Definition 1: A token space, Ω, is a collection of tokens that have attributes, A, and that can be cleared by one or more clearing parties. Exemplary notation of a token space, Ω, is shown:

Ω={T|T is cleared∩{∀Tₐ∈A}}, (1)

where T represents a token, Tₐ represents attributes of the token, and A is a set of attributes.

A token can belong to one or more token spaces. For example, if A is a set of all possible values of attributes, then all tokens belong to one token space. The token space provides a global view of tokens minted in the token space, as well as tokens that are eligible to be cleared in the token space.

Conjecture 1: Token clearing accesses the token space to clear the token “exactly once.” Two special cases can be used to verify this conjecture. One case involves token clearing with a sequence number, while another case involves token clearing by knowing a unique ID of the token.

For the first case, the token clearing is performed using a sequence number. Now that the token space is reduced to storing the sequence number, however, token clearing is sequential. For example, if a current sequence number is “10,” then a clearing party needs to process sequence number “11” before sequence number “12” is processed. This results in a trade-off between the token space and processing speed. To simplify the proof, it can be assumed that the attribute of “TTL” is in the token space. The process of clearing using a sequence number can be provided as follows:

```
Begin DB Transfer request:
  Block
  Wait Until (Tₛₙ == Last seq + 1) || (T_{TTL} >
Threshold)
    Ω.add(T_{ID})
  Regular Clearing
End DB Transfer request with Commit
```

where Last seq is the previous value of the sequence number, and Threshold is a time below the designated time-to-live of the token. The process would wait until the state number of a token is the “next in line” (e.g., after “11” is cleared, the next token to be cleared is “12”), and the token has not yet passed its time-to-live (e.g., the token has not yet self-destructed). If the two conditions are met, the token identifier can be added to the Ω Afterwards, the token clearing algorithm may be run such that the token is cleared, which results in a commit operation that finalizes an updated account balance that includes the value of the token that is cleared.

For the second case, the unique identifier of a token is used. The processing of clearing with the unique identifier is given as follows.

```
Begin DB Transfer request:
  IF T_{ID} is NOT in Tₛ
  Ω.add(T_{ID})
  Regular Clearing
End DB Transfer request with Commit
```

The process may first check if the token identifier, T_{ID}, is not currently in Ω. If the token identifier, T_{ID}, is not a part of Ω, then the token identifier can be added to Ω. Afterwards, the token clearing algorithm may be run such that the token is cleared.

Using the above, two propositions are made. Proposition 1: Assuming that party A has clearing storage S_{A}, and party B has clearing storage S_{B}, a token can be cleared more than once if S_{A} and S_{B} are network partitioned. Proposition 2: From conjecture 1, a token should only be cleared in one and only one storage to support exactly once.

In order to be entirely independent from a global storage or directory, the token itself ideally has enough information to self-identify itself to the one, and only one, authorized clearing party.

Two further propositions can be made. Proposition 3: Each token can only be classified into one and only one token space to be cleared correctly. Proposition 4: If a global storage is not feasible, or not to used, a token is partitioned into disjoined subspaces that do not intersect with each other.

Several attributes used for dividing a token space, and for operations associated with a token can be provided. Exemplary attributes of a token can include one or more of a minter ID (e.g., an identifier associated with the minting party such as an identifier of the sender computer 104), a sender ID (e.g., an identifier associated with a sending party such as the sender device 900), a receiver ID (e.g., an identifier associated with a receiving party such as the receiver device 106), a value (e.g., an amount of CBDC included in the token), a time-to-live (e.g., a time after which the token will self-destruct), and/or a station ID (e.g., an ID associated with the device used to create or process a token). For example, pairs between the sender ID and the receiver ID can divide a token space network into a set of disjoint token subspaces. The value of a token can also be used as an attribute for dividing the network. For example, for a pre-set value as the threshold, the token space can be divided into two token spaces; one token space can accept tokens with a value is larger than the threshold, and a second token space can accepts tokens with a value less than the threshold. A combination of attributes can be used to divide a token space. For example, the sender ID, the receiver ID, and the TTL can be used to construct a three-dimensional token subspace.

For auditing of the token (e.g., tracking the token), auditing information can be included in tokens. In addition to the sender ID and the receiver ID included in the attributes of a token, the token can also contain information of a source ledger address (e.g., a source ledger address such as a sender's bank account number), a destination ledger address (e.g., a destination ledger address such as a receiver's bank account number), a clearing party identifier (e.g., a receiver computer or receiver device identifier), and a time stamp (e.g., when the token was minted and/or when the token was cleared). Auditing information can be included if there is a desire to track the movement of tokens. However, auditing information may be excluded from the token if the sender/receiver prefer to be anonymous during the transfer request.

Several cryptographic and/or verification operations can be performed on tokens in the token-based digital currency system. Exemplary cryptographic and/or verification operations can include: an integrity check, which checks if a token has changed after being minted; an authenticity check, which verifies where the token is minted from by using a minter ID; a validation check, which validates a transfer request performed using a token; and time-to-clear check, which determines if the life of the token is past a time-to-live for the token. A cryptographic operation implementing a integrity check can be implemented by generating and verifying a digital signature on the token, using a public/private key encryption. For example, a sender device may use a private encryption key of a public/private key pair to generate a digital signature on a minted token. Once a receiver device receives the minted token, the receiver device may retrieve the public encryption key associated with the private encryption key to verify the digital signature of the minted token. In doing so, the receiver device can verify the integrity of the minted token (e.g., by checking the token attributes of the signed minted token are the same as the token attributes in the minted token). A cryptographic operation implementing an authenticity check can be implemented by comparing a minter ID in a set of attributes of a token to an expected minter ID. For example, in a transfer, a receiver device may receive a minted token from a sender device. The minted token can comprise a minter ID in the token attributes. The receiver device may compare the minter ID in the token attributes to an expected minter ID (e.g., an expected minted ID may include a previously received minted ID from a prior transfer request).

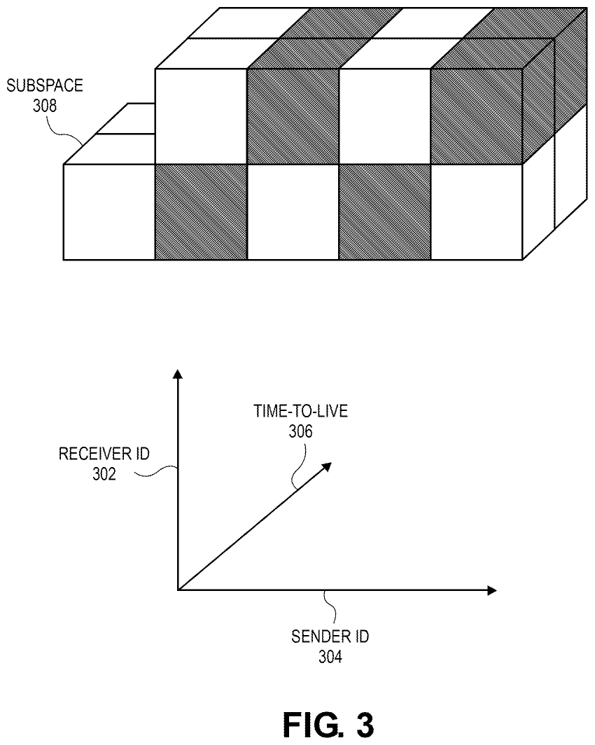

FIG. 3 shows an illustration of a three-dimensional subspace model according to embodiments. The token subspace can be created using attributes of sender ID, receiver ID, and time-to-live. The three attributes can act as a three-dimensional coordinate system. For example, the receiver ID 302 axis, the sender ID 304 axis, and the time-to-live 306 axis. The token space can be divided to create a subspace 308. For example, the subspace 308 can include tokens that are from a specific sender to a specific receiver, and that have a time-to-live in a specific range. For tokens in the subspace 308, tokens can only be accepted by a specific receiver within a specific period of time decided by the time-to-live. Although a three-dimensional token subspace is shown, the example can be extrapolated to many dimensions. For example, an n-dimensional token subspace can be formed using n-parameters including one or more of a sender ID, a receiver ID, a time-to-live, a value, a device type, etc.

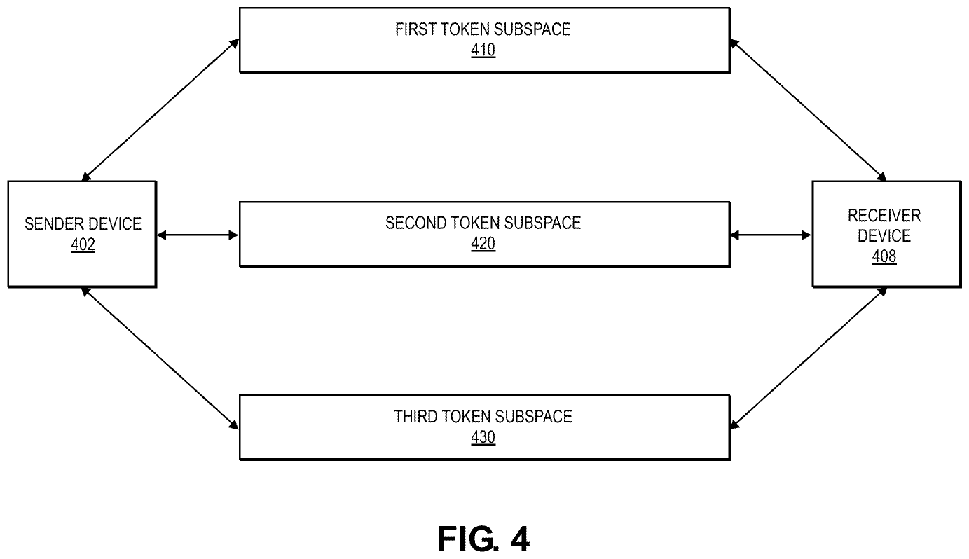

FIG. 4 shows a block diagram of a sender device and a receiver device communicating using three token subspaces according to embodiments. A sender operating a sender device 402 and a receiver operating a receiver device 408 are not limited to accessing a single token subspace. Senders and receivers are permitted access to multiple token subspaces modeled by token attributes. For example, a first token subspace 410 may restrict tokens to include tokens with attributes including a time-to-live of below 60 seconds, and a value of less than 1,000. The first token subspace 410 essentially states that tokens can be accepted by the receiver device 408 only if the token's value is less than 1,000 and the time-to-live is less than 60 seconds. A second token subspace 420 restrict tokens to include tokens with attributes including a sender ID of the sender device 402, and a receiver ID of the receiver device 408, and a time-to-live below 60 seconds. A third token subspace 430 may restrict tokens to include tokens with attributes including a time-to-live of below 60 seconds, and a value of greater than 1,000. For the first token subspace 410 and the third token subspace 430 there is no restriction on the sender ID and receiver ID included in the token attributes. This means any pair of sender device and receiver device can access the two token subspaces. However, in the second token subspace 420, token is constrained to have attributes including a sender ID of the sender device 402 and a receiver ID of the receiver device 408.

If some token subspaces are partitioned with the rest of the token space (e.g., caused by offline, or communication failure) an auditing log cannot track a token in real-time. Tracking all tokens can be done using a memory that can fit a token subspace in the dimensions of a global token space. For example, the receiver device 406 operating offline can process tokens in three token subspaces described and is able to recognize tokens in the subspaces to prevent double spending. A token minter operating offline, mints a token in a pre-agreed token subspace for a receiver so that the receiver can receive and process the token. For example, the sender device 402 and the receiver device 406 may agree on token attributes used to define a token subspace. The sender device 402 may mint a token in the pre-agreed token subspace, so that the receiver device 406 may receive the token and clear the token in the pre-agree token subspace. After the devices return to operating online, each token in the offline model be published to an auditing log to achieve consistency.

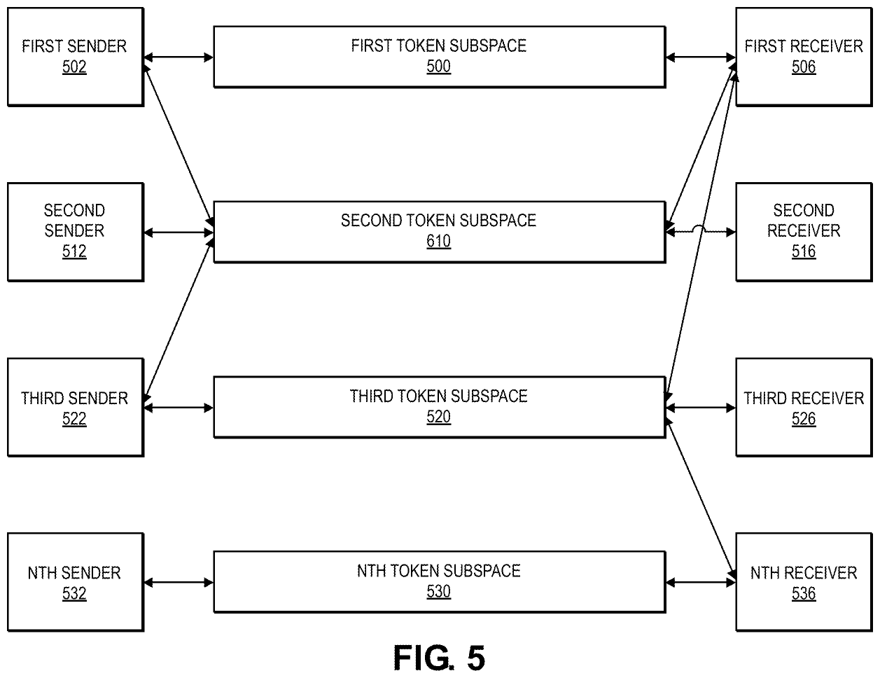

FIG. 5 shows a block diagram illustrating a plurality of users communicating through a plurality of token subspaces according to embodiments. The plurality of users can be a plurality of senders (e.g., a first sender 502, a second sender 512, a third sender 522, and a nth sender 532, operating respective sender devices) and receivers (a first receiver 506, a second receiver 516, a third receiver 526, and an nth receiver 536 operating respective receiver devices) can communicate with one another using one or more token subspaces (e.g., a first token subspace 500, a second token subspace 510, a third token subspace 520, and an nth token subspace 530). For example, similar to FIG. 4, a first sender 502 may communicate with a first receiver 506 using a first token subspace 500, and a second token subspace 520. Additionally, the first sender 502 may communicate with a second receiver 516 using a second token subspace 510. Other senders shown in FIG. 5 can communicate with other receivers using pre-agreed token subspaces.

Pre-planning of token spaces can be performed. When there is no partitioning of subspaces, all parties in the token-based digital currency system can successfully connect with each other. Hence, it is possible to track all tokens online by building a global auditing log for recording the transfer requests for tokens. Using the token attributes, the token-based digital currency system can be divided into token subspaces. Aₛ a result, the global token space of the system is divided into token subspaces, each of which is disjoint from one another. In each token subspace, the operational complexity is reduced compared to the global token space, as the size of token subspaces are reduced to a smaller scale.

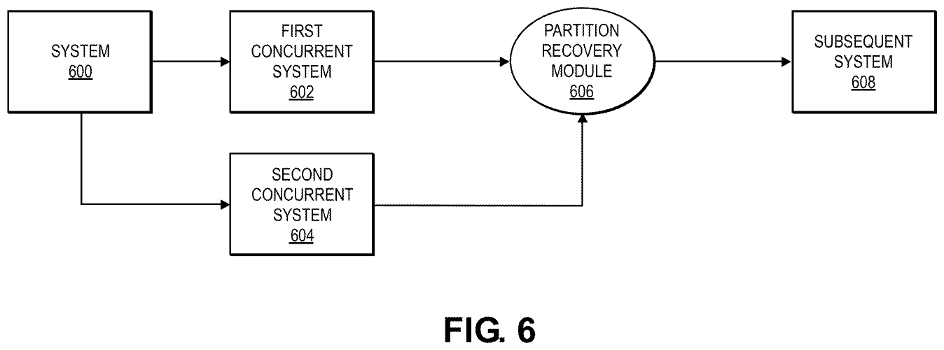

FIG. 6 shows a block diagram of a partition model. The partition model of FIG. 6 can correspond to many traditional distributed systems. Network partitioning in distributed systems can occur due to communication failures. To maintain the performance guarantee of availability and consistency of the distributed system during partitioning, there is a need to manage the partitions. A partitioning model can include three steps including detecting the partition, entering the partition model with limited operations, and initiating partition recovery once online communication is restored. Specifically, a system 600 may be in an initial state. If a device in a system 600 loses connection, the device may cause a partition, resulting in the system 600 being split into a first concurrent system 602 (e.g., a copy of the system 600) and a second concurrent system 604 (e.g., a copy of the system 600 which then can be modified by the offline device). When the system detects a partition, both sides of the partition enter a partition model. When the partition ends, the partition recovery can begin. Once the device returns online, a partition recovery module 606 may merge the first concurrent system 602 and the second concurrent system 604 to form a subsequent system 608.

This setup requires high computational complexity to remember both the first concurrent system 602 and the second concurrent system 604. For example, the partition recovery module 606 may compare the first concurrent system 602 to the second concurrent system 604. The partition recovery module 606 may form the subsequent system 608 by including the most recent data in both the first concurrent system 602 and the second concurrent system 604. For a system with many devices, several devices going offline may cause a large amount of partitioning. Thus, the partitioning recovery module 606 is burdened to compare many concurrent systems.

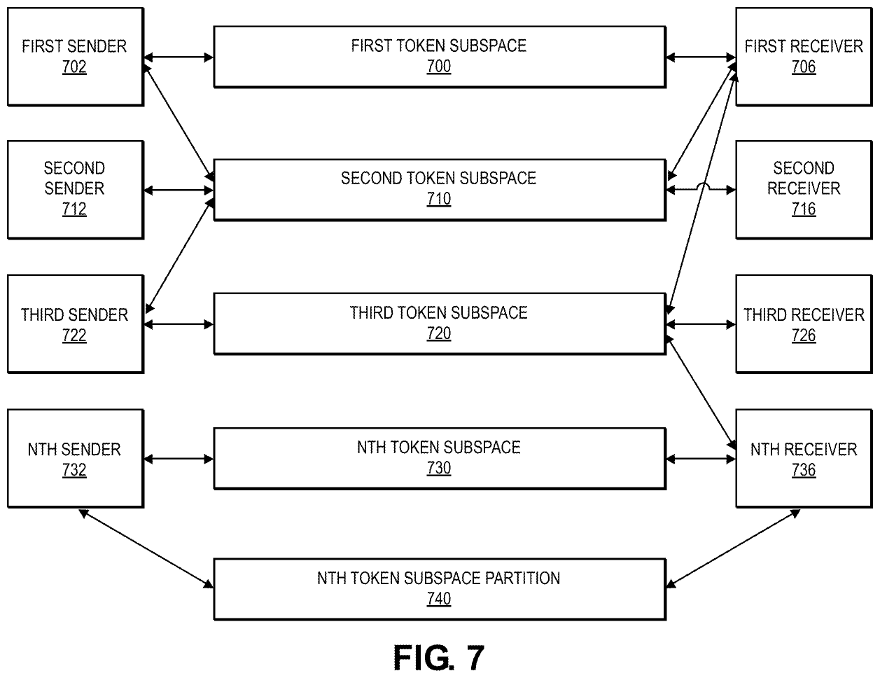

FIG. 7 shows a block diagram illustrating a plurality of users (e.g., a first sender 702, a second sender 712, a third sender 722, and an nth sender 732 operating respective sender devices, and a first receiver 706, a second receiver 716, and a third receiver 726, and an nth receiver 736 operating respective receiver devices) communicating through a plurality of token subspaces (e.g., a first token subspace 700, a second token subspace 710, a third token subspace 720, and an nth token subspace 730) and a subspace partition (e.g., an nth token subspace partition 740) according to embodiments.

The system of FIG. 7 includes an nth token subspace partition 740. The nth token subspace partition 740 may be a partition of the nth token subspace 730. The system of FIG. 7 can be seen as a specific example of the partition model of FIG. 6. The nth sender 732 and the nth receiver 736 may attempt to perform a token-based transfer request or value transfer using the nth token subspace 730. A communication error in the nth token subspace 730 may occur, causing the nth sender 732 and the nth receiver 736 to operate offline. The nth sender 732 and the nth receiver 736 can communicate with each other over a local connection to check if there is a substitute token subspace that can be used to communicate. If there exists a substitute token subspace, the nth sender 732 can migrate from the nth token subspace 730 to the nth token subspace partition 740 to pass a minted token to the nth receiver 736. Operations during partitioning can be limited. Examples of operations that can be limited can include receivers of tokens not being able to immediately clear received tokens to prevent double spending and maintain consistency of the system. Once online communication is reestablished, the minted token passed through the nth token subspace partition 740 can be published by both the nth sender 732 and the nth receiver 736 to an auditing log. Once the auditing log verifies the validity of the token (e.g., using a cryptographic operation), value included in the token can be claimed by the nth receiver 736.

Aₛ compared to the partition model shown in FIG. 6, the token subspace partitioning of FIG. 7 provides a number of improvements. The token subspaces shown in FIG. 7 are disjoint subspaces. For example, tokens in the nth token subspace 730 exist only in the nth token subspace 730. Thus, when the nth token subspace partition 740 is created, any further tokens added to the nth token subspace partition 740 do need to be added to other token subspace

There exist tradeoffs in designing token spaces of the token-based digital currency system for balancing the risk of double spending of tokens and the flexibility of the use of tokens in the token space. First, consider an extreme case where there is no sender ID and receiver ID used in subspace planning. In this case, the token attributes of the token may only contain a minter ID, a value, and a time-to-live, which can make the token work like fiat currency. Hence, the global token space can be viewed as a global currency space. Since there is no restriction on the sender and on the receiver, the use of the token has a very high flexibility. However, the risk of double spending is also tremendous under this scenario, as any party in the digital currency system could copy a token and re-use with multiple receivers. Additionally, the operation costs associated with maintaining such a global currency space is also significant. Aₛ a second example, consider a token space with parameters including a sender ID, a receiver ID, a minter ID, and a time-to-live. In this second example, the risk of double spending for tokens in this space is low as the use of every token is heavily constrained. However, the flexibility of using the tokens in this space is low, because each token can only accepted by a single receiver.

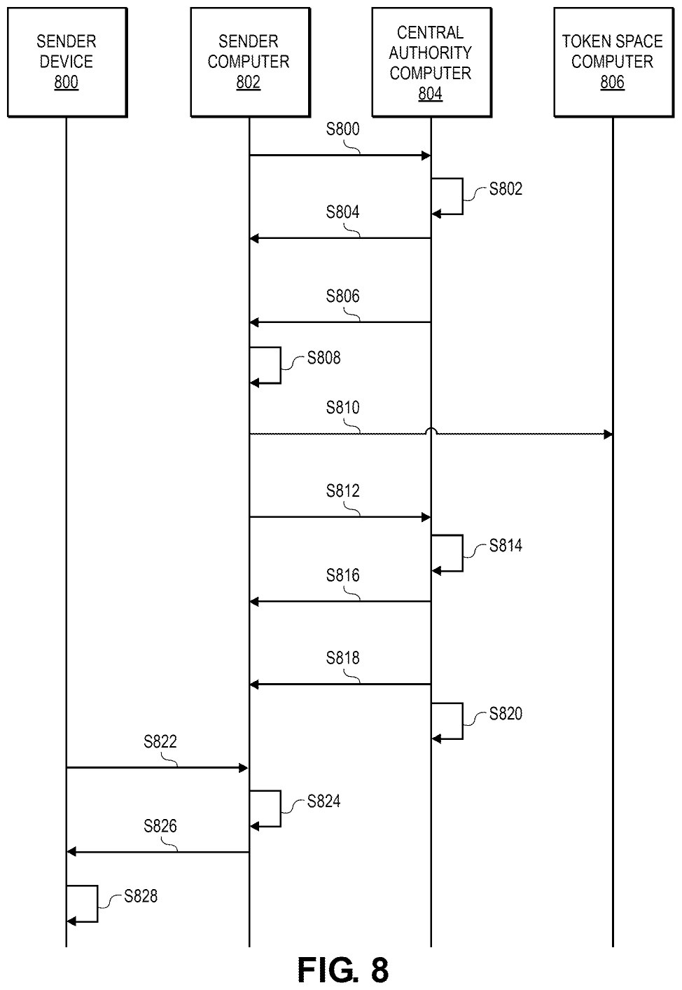

FIG. 8 shows a flow diagram for a sender computer 802 establishing a token space according to embodiments. The sender computer 802 may perform the steps of FIG. 8 before becoming an issuer of digital currency accounts. For example, both the sender computer 104 and the receiver computer 108 can perform the steps of FIG. 8 before they are able issue digital currency accounts to the sender device 900 and the receiver device 106, respectively. A central authority computer 804 can be operated by a central authority that manages access to a token-based digital currency, and maintains a distributed ledger that keeps track of all tokens.

In step S800, the sender computer 802 may transmit a request to become a token operator to the central authority computer 804. The sender computer 802 may be operated be a financial institution computer such as an issuer bank computer. The issuer bank computer can manage an account associated with a sender operating the sender device 800. The sender device 800 may be a device such as a mobile phone or laptop computer. The sender operating the sender device 800 may be a sender that wishes to transfer value (e.g., send money) to a receiver operating a receiver device.

In step S802, after receiving the request from the sender computer 802, the central authority computer 804 may choose to approve or deny the request. For example, the central authority computer 804 may determine the sender computer 802 is approved based on any number of factors including the financial standing or trustworthiness of the sender operating the sender computer 802.

In step S804, after approving the sender computer 802, the central authority computer 804 may transmit root key(s) to the sender computer 802. The root key(s) may be used to operate (e.g., to mint and clear) on tokens. For example, the root key(s) can be used by the sender computer 802 when it performs operations on tokens, such as applying a digital signature to a token. In this example, the root keys may be a verification/signing key pair, where the signing key is used to generate the digital signature. The digital signature can prove the authenticity of a minted token (e.g., the digital signature can prove the token was minted by the sender computer 802). The root key may be transmitted to the sender computer 802 using any suitable secure cryptographic key exchange protocol such as Diffie-Hellman. In some embodiments, the sender computer 802 may use the root keys to generate derived keys. For example, the sender computer 802 may be a first computer in a network of computers. The sender computer 802 may use the root key received to generate a derived key for a second computer in the network of computers. The derived key may thus be used to identify that a token was minted by the second computer.

In step S806, after providing the root key to the sender computer 802, the central authority computer 804 may transmit a unique identifier to the sender computer 802. The unique identifier may be an identifier as, for example, a minting party and/or clearing party identifier. The unique identifier may be in any suitable form including a predetermined or random strings of characters.

In step S808, after receiving the root key and the unique identifier(s), the sender computer 802 may begin to issue digital currency accounts. The sender computer 802 may store the root key and the unique identifier, and may use them when issuing digital currency accounts to users.

In step S810, after being approved to issue digital currency accounts, the sender computer 802 may communicate with a token space computer 806 to set up a new token space. The sender computer 802 may include parameters that define the new token space. The new token space can be used to generate tokens that include token attributes within the set of parameters. For example, the sender computer 802 may wish to create a new token space defined by parameters that will allow for the processing of tokens that have attributes including a sender identifier for the sender device 800, a time-to-live less than 24 hours, and a value less than $500.

In step S812, after setting up a new token space, the sender computer 802 may transmit the request to set up the new token space to the central authority computer 804. The request may include the parameters (e.g., includes the sender identifier for the sender device 800, a time-to-live less than 24 hours, and a value less than $500) of the new token space.

In step S814, after receiving the request to set up the new token space from the sender computer 802, the central authority computer 804 may review the parameters of the new token space. The central authority computer 804 may ensure the new token space, as defined by the parameters in the request, does not overlap with existing token spaces. For example, the central authority compute 804 can search a database comprising stored token spaces.

In step S816, after verifying the new token space does not overlap with existing token space, the central authority computer 804 may verify that the sender computer 802 has established the capability to maintain the new token space. For example, the central authority computer 804 may verify the sender computer 802 is able to maintain a source ledger for holders of digital currency accounts, transmit details of tokens to an auditing computer, operate or communicate with a token space computer, mint and clear tokens, etc. The central authority computer 804 can do this by checking the hardware and software features of the sender computer 802.

In step S818, after verifying the sender computer 802 is able to maintain the new token space, the central authority computer 804 may transmit a token space operational root key(s) to the sender computer 802. The token space operational root key(s) can be used for cryptographic operations of the token space. For example, the token space operation root keys can be a public/private key pair, and can be used to verify the integrity of tokens minted in the new token space. The private key can be used to generate a digital signature on a minted token. The public key may thereafter be used to verify a minted token has not been changed, by comparing the minted token to the digital signature (e.g., using the public key to decrypt the digital signature and comparing the minted token to the decrypted digital signature).

In step S820, after providing the token space operational root key(s) to the sender computer 802, the central authority computer 804 can publish the new token space and parameters to a distributed ledger such as the distributed ledger 100 in FIG. 1. Thereafter, the new token space may be used by the sender computer 802 to mint tokens.

In step S822, after the new token space is published, a sender operating a sender device 800 may transmit a request to provision a local token space to the sender computer 802. The sender device 800 may thereafter receive parameters of the local token space. For example, it may receive parameters such as (i) less than $5, (ii) to recipient A, and (iii) from device type B for the local space. In other examples, the sender device 800 may receive a token template that includes the parameters of the local token space. The token template may be an empty token (e.g., a token with no value) that includes data fields for at least some of the parameters of the local token space. After obtaining the local token space, the sender device 800 may operate offline by maintaining an offline copy of a source ledger on the sender device 800. The local token space may be a token subspace that stores tokens minted and cleared by the sender device 800.

In step S824, after receiving the request to provision the local token space from the sender device 800, the sender computer 802 may verify the local token space. For example, the sender computer 802 may verify the local token space does not overlap with other local token spaces. The sender computer 802 may also generate local token space keys. In some embodiments, they may be generated using or derived from root keys obtained from a central authority computer. The local token space keys can be similar to the token space operation root key(s) of step S818. The local token space keys can be used to perform cryptographic operations (e.g., verifying the integrity of the token) of the local token space.

In step S826, after generating local token space keys, the sender computer 802 may transmit the local token space keys to the sender device 800.

In step S828, after receiving the local token space keys, the sender device 800 may maintain the local token space. The local token space can communicate with an offline copy of a source ledger to mint tokens. For example, the local token space can withdraw a value from a local ledger to add to a base token. While the sender device 800 has a connection to the sender computer 802, the local ledger may be updated to match the source ledger maintained by the sender computer 802.

Although the flow diagram of FIG. 8 was described in reference to a sender, a sender device 800, and asender computer 802, the process may also be performed by a receiver, a receiver device, and a receiver computer.

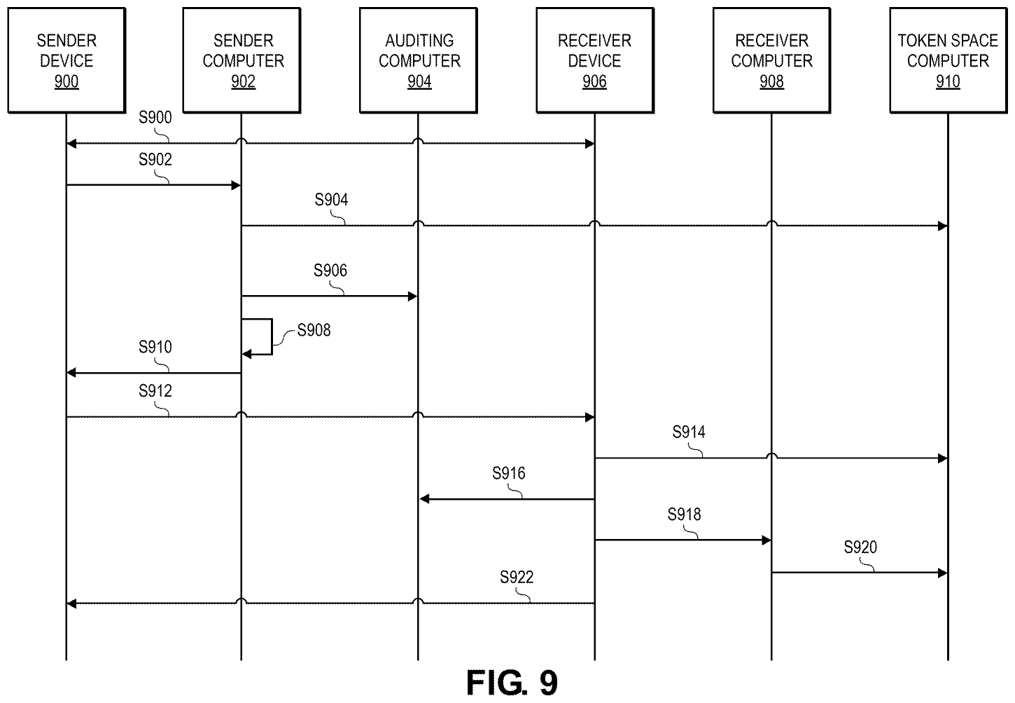

FIG. 9 shows a flow diagram for an online minting and clearing flow according to embodiments. The system of FIG. 9 includes a sender operating a sender device 900. The sender may wish to transmit a digital currency token to a receiver operating a receiver device 906 (e.g., for a transfer request). The sender device 900 may be in online communication with a sender computer 902 that maintains a digital currency account for the sender. The sender computer 902 could be a financial institution computer that holds an account of the sender of the sender device 900. Similarly, the receiver device 902 may be in online communication with a receiver computer 908 that maintains a digital currency account for the receiver. An auditing computer 904 may be in communication with, and receive information about tokens. The token space computer 910 may manage a token space that is defined by a set of parameters. Aₛ an example, the token space can be a space of tokens that satisfy a particular set of parameters. The token space may be implemented by a blockchain or a data file by the token space computer 910. The token space computer 910 may be managed by the authorizing entity operating the sender computer 902, or may be a separate entity that manages tokens spaces.

In step S900, the sender device 900 can establish a communication channel with the receiver device 906 to begin a transfer request. The sender device 900 may obtain a receiver identifier, A_{R}, from the receiver device 906 to be used for a token minting process. Similarly, the receiver device 906 may obtain a sender identifier, Aₛ, from the sender device 900 to be used for a token clearing process. In some embodiments, the sender device 900 may additionally receive a token template that indicates one or more preferred token spaces from the receiver device 906. For example, the token template may comprise a set of token attributes that are within the parameters of a preferred token space. Aₛ an illustration, the parameters of the preferred token space may include a time-to-live less than 24 hours, an amount less than $500, a receiver identifier for the receiver device 906, and a sender identifier for the sender device 900. The token template can include token attributes which satisfy the parameters, such as a time-to-live of 12 hours, an amount of $5, and a receiver identifier of the receiver 906. In other embodiments, the sender device 900 may obtain a token space identifier that indicates one or more preferred token spaces from the receiver device 906. The sender device 900 could populate the token template with one or more of the above example attributes or additional attributes (e.g., a sender identifier).

In step S902, after determining a preferred token space that will be used for the transfer request between the sender device 900 and the receiver device 906, the sender device 900 may transmit a request to the sender computer 902 to mint a token. In some embodiments, the request may include the token template which includes a set of token attributes to be used for a token, such as an amount, v, to be deducted from a source ledger (e.g., a bank account of the sender) and set to the token, the sender identifier, Aₛ, and the receiver identifier, A_{R}. In some embodiments, the request to mint a token may include the token space identifier.

In step S904, after receiving the token minting request, the sender computer 902 may communicate with the token space computer 910 to create a base token in the token space managed by the token space computer 910. In some embodiments, the sender computer 902 may use the token space identifier to identify the token space computer 910. In some embodiments, the base token initially be created as an empty token. The sender computer 902 may deduct the amount, v, from the source ledger associated with the sender operating the sender device 900 and assign it to the base token. In some embodiments, the token space computer 910 may provide a token template to the sender computer 902. In some embodiments, the token template received (e.g., in step S902 or step S904) may be used to update the base token. For example, the token template may include a set of token attributes to be set to the base token. The parameters of the token space may include the set of token attributes in the token template (e.g., the token space may require tokens to include a receiver identifier equal to A_{R}, and it may also require that the value, v, of the token be larger/smaller than a threshold, etc.). The sender computer 902 may set a status of the token to “minted” (e.g., by setting a status indicator in the token or in the token space associated with the token to equal to “minted” such as T_{State}=1).

The token space may store the status of the tokens, a token ID, minting party ID (e.g., an identifier associated with the party who created the token—e.g., the sender identifier), clearing party ID (e.g., an identifier associated with the party who cleared the token—e.g., the receiver identifier), a timestamp, and/or any other suitable information of the base or minted token.

In step S906, the sender computer 902 may publish the token to the auditing computer 904. This may be done directly after the token has been added to the token space or may be done asynchronously. The auditing computer 904 may be a maintain an auditing log that acts as a public token ledger, which may store auditing information of the token. Auditing information can include the sender ID, the receiver ID, a source ledger address (e.g., the sender's bank account number), destination ledger address (e.g., the receiver's bank account number), clearing party identifier (e.g., an identifier associated with the receiver computer 908), timestamp (e.g., a time when the token was minted and/or cleared), etc. The auditing log may be accessed by any third-party to verify transfer requests performed using a token associated with a given token ID (e.g., the third party may provide a token ID to the auditing computer 904 and receive a minting party ID from which they can communicate with to request access for the transfer request data associated with the token ID). In some embodiments, step S906 may instead be performed after forming a minted token in step S908.

In step S908, the sender computer 902 may finalize the base token by signing the base token with a private key of a public/private key pair (e.g., a private key of the token space operational root keys of step S814) to produce a digital signature on the base token. By signing the base token, the sender computer 902 forms a minted token. After the base token has been signed by the sender computer 902, the base token is a minted token, which is an immutable token, meaning the information of the token (e.g., token attributes) cannot be changed (e.g., the sender device 900 has committed the amount to the token).

In step S910, after the minted token has been formed, the sender computer 902 may transmit the minted token to the sender device 900. The minted token may comprise the token attributes that were set to the base token.

In step S912, after receiving a minted token from the sender computer 902, the sender device 900 may transmit a transfer request message comprising the minted token to the receiver device 906. The transfer request message may include the minted token itself along with any other suitable transfer request data.

In step S914, in response to receiving the transfer request, the receiver device 906 may verify the minted token. The verification may be done via several cryptographic algorithms (e.g., verifying the integrity of the token, verifying the authenticity of the token, etc.). For example, the receiver device 906 may verify the integrity of the token by verifying the digital signature (e.g., comparing the signed token attributes of the digital signature to the token attributes of the minted token) on the minted token using a public key associated with the private key used to produce the digital signature on the minted token. The receiver device 906 may then verify the token attributes of the minted token (e.g., the TTL can be checked to determine if the token is still valid). The receiver device 906 may access the token space computer 910. The token space computer 910 may be used to ensure that the minted token has not been cleared more than once. The token space computer 910 can be used to check the status of the minted token, such that the receiver device 906 can confirm it is available for use. For example, when the status of the minted token is implemented by a binary bit T_{Status} as shown in Table 1, the receiver device 906 may confirm T_{Status} has a value equal to “1,” which indicates the token is “minted.” If the token has a “minted” status, then the token space computer 910 may modify the status of the minted token to “cleared.” For example, if the token status is in the token itself, the receiver device 906 may modify the binary bit T_{Status} to have a value equal to “0,” which indicates the token is “cleared.” In another example, if the token status is not within the token itself, is the receiver device 906 may transmit an update to the token space computer 910 to update the status of the token to “cleared.”

In step S916, after receiving the minted token from the sender computer 902, the receiver device 906 may generate a verification message and transmit the verification message to the auditing computer 904. This step may be performed directly after the minted token has been verified using the token space computer 910 or may be performed asynchronously. The receiver device 906 may pass the token ID to the auditing computer 904. Similar to step S914, the receiver device 906 may use the auditing log maintained by the auditing computer 904 to verify information of the minted token. For example, the receiver device 906 may retrieve a second minted token (e.g., a copy of the minted token) corresponding to the minted token from the auditing computer 904. The receiver device 906 may compare information of the minted token to the second minted token received from the auditing log.

In step S918, after the receiver device 906 verifies the minted token, the receiver device 906 may transmit a request to the receiver computer 908 to clear the minted token. The request may include the minted token itself. The receiver computer 908 may be operated by a financial institution of the receiver operating the receiver device 906. The financial institution may hold an account of the receiver operating the receiver device 906.

In step S920, after receiving the minted token, the receiver computer 908 may query the token space computer 910 for the status of the token. The query may include the token ID, and the token space computer 910 may confirm that the status has been set to “cleared”. After confirming that the status of the token is set to “cleared”, the receiver computer 908 may deposit the value included in the cleared token into an account associated with the receiver device 906 (e.g., a bank account of the receiver). Aₛ the token itself holds value (e.g., the token can be exchanged for fiat currency at any point), the receiver computer 908 may deposit the value directly into the account associated with the receiver device 906, without the need for a settlement process to occur.

In step S922, after the token data has been stored in the destination ledger, the receiver device 906 may transmit remittance information to the sender device 900 to confirm the details of the completed transfer request.

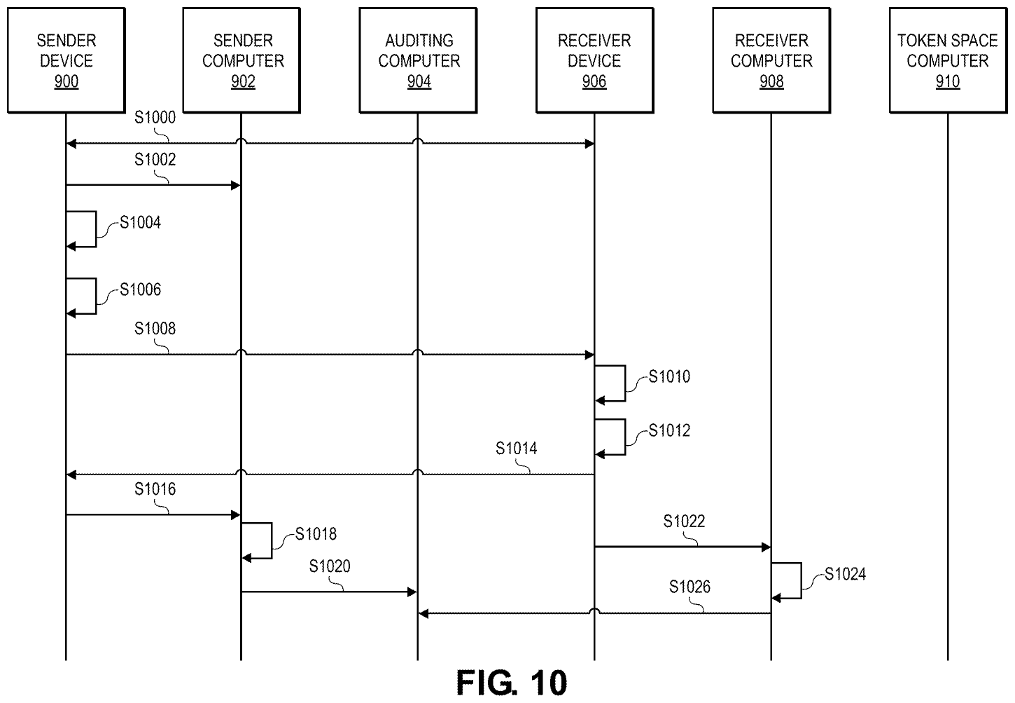

FIG. 10 shows a flow diagram for an offline minting and clearing flow according to embodiments. The system of FIG. 10 may be similar to the system shown in FIG. 9. The sender operating the sender device 900 may wish to perform a transfer request with the receiver operating the receiver device 906. However, in the flow described by FIG. 10, the sender and/or the receiver device may not have an online connection to the sender computer 902 or the receiver computer 908. In the system of FIG. 10, because both the sender device 900 and the receiver device 906 operate without communication to other devices, the functions performed by the token space computer 910 in FIG. 9 are instead performed at the receiver device 906. Aₛ such, the token space may be a local token space stored on the receiver device 906

In step S1000, the sender device 900 can establish a communication channel with the receiver device 906 to begin a transfer request. The sender device 900 may obtain a receiver identifier, A_{R}, from the receiver device 906 to be used for a token minting process. Similarly, the receiver device 906 may obtain a sender identifier, Aₛ, from the sender device 900 to be used for a token clearing process. In some embodiments, the sender device 900 may additionally receive a token template that indicates one or more preferred token spaces from the receiver device 906. For example, the token template may comprise a set of token attributes that are within the parameters of a preferred token space. Aₛ an illustration, the parameters of the preferred token space may include a time-to-live less than 24 hours, an amount less than $500, a receiver identifier for the receiver device 906, and a sender identifier for the sender device 900. The token template can include token attributes which satisfy the parameters, such as a time-to-live of 12 hours, an amount of $5, and a receiver identifier of the receiver 906. In other embodiments, the sender device 900 may obtain a token space identifier that indicates one or more preferred token spaces from the receiver device 906.

In step S1002, the sender device 900 may transmit a token minting request to the sender computer 902 to mint a token. The sender computer 902 may be a financial institution computer that holds an account of the sender of the sender device 900. The request may include several token attributes to be set on the token such as an amount, v, to be deducted from a local ledger (e.g., an offline copy of an account of the sender) and set to the token, the sender identifier, Aₛ, and the receiver identifier, A_{R}. However, the sender device 900 may receive a connection failure response (e.g., the sender device 900 may not have an online connection to communicate with the sender computer 902).

In step S1004, in response to the token mint request failing, the sender device 900 may generate a base token in a local token space. The sender device 900 may generate the base token in the local token space associated with the set of token attributes indicated by the receiver device 906 in step S1000. The sender device 900 may then deduct the amount, v, from a local ledger associated with the sender, and assign it to the base token. The base token may and set a status of the token to “minted” (e.g., T_{Status}=1). The local token space may store the status of the token, a token ID, a minting party ID, a clearing party ID, a timestamp, and any other suitable transfer request data associated with the token.

In step S1006, the sender device 900 may finalize the base token by signing the base token with a private key (e.g., the local token space keys of step S824) to produce a digital signature on the base token. By signing the base token, the sender device 902 forms a minted token. After the base token has been signed by the sender device 902, the base token is a minted token, which is an immutable token, meaning the information of the token (e.g., token attributes) cannot be changed (e.g., the sender device 900 has committed the amount to the token).

In step S1008, after forming the minted token, the sender device 900 may transmit a transfer request to the receiver device 906. The transfer request may include the minted token itself and any other suitable transfer request data.

In step S1010, a response to receiving the transfer request, the receiver device 906 may verify the minted token is in the token space indicated by the receiver device 906 in step S1000. The verification may further comprise verifying the token via several cryptographic algorithms (e.g., verifying the integrity of the token, verifying the authenticity of the token, etc.). For example, the receiver device 906 may verify the integrity of the token by verifying the digital signature (e.g., comparing the signed token attributes of the digital signature to the token attributes of the minted token) on the minted token using a public key associated with the private key used to produce the digital signature on the minted token. The receiver device 906 may then verify the token attributes of the minted token (e.g., the TTL can be checked to determine if the token is still valid).

In step S1012, after verifying the minted token, the receiver device 906 may then clear the minted token. For example, when the status of the minted token is implemented by a binary bit T_{Status} as shown in Table 1, the receiver device 906 may confirm T_{Status} has a value equal to “1,” which indicates the token is “minted.” If the token has a “minted” status, then the token space computer 910 may modify the status of the minted token to “cleared.” For example, the receiver device 906 may modify the binary bit T_{Status} to have a value equal to “0,” which indicates the token is “cleared.” The receiver device 906 may then use a private key of a private/public pair (e.g., local token space keys of step S824) to sign the cleared token to generate a clearing signature on the cleared token.

In step S1014, after clearing the minted token, the receiver device 906 may transmit the cleared token and the clearing signature to the sender device 900.

In step S1016, once the sender device 900 can establish an online connection with the sender computer 902, the sender device 900 may transmit changes in the local token space and the local ledger to the sender computer 902. The update may comprise transfer request details (e.g., the cleared token and the clearing signature) from one or more transfer requests completed by the sender device 900 while it was offline.

In step S1018, after receiving offline updates from the sender device 900, the sender computer 902 may verify the clearing signature. For example, the sender computer 902 may retrieve a public key associated with the private key used to generate the clearing signature. The sender computer 902 may then update an online ledger associated with the sender. The update to the online ledger may include deducting the value, v, of the cleared token from the online ledger associated with the sender device 900.

In step S1020, the sender computer 902 may publish the token to the auditing computer 904. This may be done directly after the value of the cleared token has been added to the local ledger or may be done asynchronously. The auditing computer 904 may be a maintain an auditing log that acts as a public token ledger, which may store auditing information of the token. Auditing information can include the sender ID, the receiver ID, a local ledger address (e.g., the sender's bank account number), destination ledger address (e.g., the receiver's bank account number), clearing party identifier (e.g., an identifier associated with the receiver computer 908), timestamp (e.g., a time when the token was minted and/or cleared), etc. The auditing log may be accessed by the third-party to verify transfer requests performed using a token associated with a given token ID (e.g., the third party may provide a token ID to the auditing computer 904 and receive a minting party ID from which they can communicate with to request access for the transfer request data associated with the token ID).

Similarly, in step S1022, once the receiver device 906 can establish an online connection with the receiver computer 908, the receiver device 906 may transmit the cleared token to the receiver computer 908.

In step S1024, after receiving the cleared token, the receiver device 906 may deposit the value included in the cleared token into an account associated with the receiver device 906 (e.g., a bank account of the receiver). Aₛ the token itself holds value (e.g., the token can be exchanged for fiat currency at any point), the receiver computer 908 may deposit the value directly into the account associated with the receiver device 906, without the need for a settlement process to occur.

In step S1026, after depositing the value, the receiver computer 908 may then publish the cleared token to the auditing computer 904. This may be done directly after the value is deposited or may be done asynchronously. The receiver computer 908 may transmit the same or different auditing information as the sender computer 902 in step S1020. For example, some auditing information may be updated, such as the timestamp or the clearing party ID to include information about how the token was cleared.

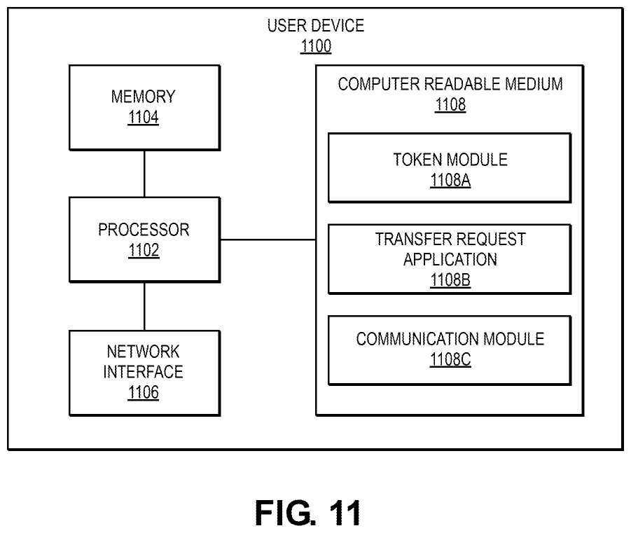

FIG. 11 shows a block diagram of a user device 1100 according to embodiments. The user device 1100 may comprise a processor 1102, which may be coupled to a memory 1104, a network interface 1106, and a computer readable medium 1108. Examples of the user device 1100 may be a sender device, or a receiver device.

The memory 1104 may contain tokens, such as minted or cleared tokens, offline copies of ledgers, etc. The memory 1104 may be coupled to the processor 1102 internally or externally (e.g., via cloud-based data storage), and may comprise any combination of volatile and/or non-volatile memory such as RAM, DRAM, ROM, flash, or any other suitable memory device.

The network interface 1106 may include an interface that can allow the user device 1100 to communicate with external computers and/or devices. The network interface 1106 may enable the user device 1100 to communicate data to and from another device such as an authorizing entity computer, an auditing computer, etc. Some examples of the network interface 1106 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 1106 may include Wi-Fi. Data transferred via the network interface 1106 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 1106 and other devices via a communications path or channel. Aₛ noted above, any suitable communication path or channel may be used such as, for instance, a wire or cable, fiber optics, a telephone line, a cellular link, a radio frequency (RF) link, a WAN or LAN network, the Internet, or any other suitable medium.

For a sender device, the computer readable medium 1108 may comprise code, executable by the processor 1102, for a method comprising: generating a base token in a token space associated with parameters, wherein the base token comprises token attributes within the parameters and an amount; signing the base token to form a minted token; and transmitting, to a receiver device, a transfer request comprising the minted token.

Alternatively, for a receiver device, the computer readable medium 1108 may comprise code, executable by the processor 1102, for a method comprising: receiving, by a receiver device associated with a receiver from a sender device associated with a sender, a transfer request comprising a minted token in a token space associated with parameters, wherein the minted token comprises token attributes contained within the parameters; verifying, by the receiver device, the minted token by checking that token attributes of the minted token are within the parameters of the token space; modifying, by the receiver device, a status of the minted token to form a modified token; and signing, by the receiver device, the modified token to form a cleared token.

The computer readable medium 308 may comprise several software modules including, but not limited to, a token module 1108A, a transfer request application 1108B, and a communication module 1108C.

The token module 1108A may comprise code that causes the processor 1102 to manage token-based digital currency. For example, the token module 1108A can comprise code that allows the user device 1100 to maintain a digital currency account. The token module 1108A may be used to mint and clear tokens. Additionally, the token module 1108A may create offline copies of ledgers (e.g., source ledgers and destination ledgers), and provide updates to online ledgers maintained by authorizing entity computers.

The transfer request application 1108B may comprise code that causes the processor to perform transfer requests. For example, the transfer request application 1108B may allow the user device 1100 to perform a transfer request with another user device. For example, the transfer request application 1108B can connect a sender device to a receiver device and receive a token template over a connection established. The transfer request application 1108B can communicate with the token module 1108A to transfer token-based digital currencies to accounts of other users to complete transfer requests.

The communication module 1108C may comprise code that causes the processor 1102 to generate messages, forward messages, reformat messages, and/or otherwise communicate with other entities.

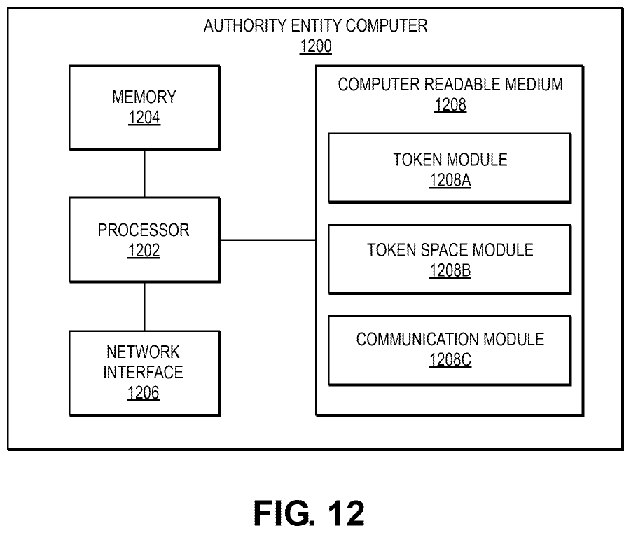

FIG. 12 shows a block diagram of an authorizing entity computer 1200 according to embodiments. The authorizing entity computer 1200 may comprise a processor 1202, which may be coupled to a memory 1204, a network interface 1206, and a computer readable medium 1208. Examples of the authorizing entity computer 1200 may be a sender computer, or a receiver computer.

The memory 1204 and the network interface 1206 may have the same or different features to the previously described memory 1104 and network interface 1106.

The computer readable medium 1208 may comprise code, executable by the processor 1202, for a method comprising: transmitting, by an authorizing entity computer to a central authority computer, a request to become a token operator; receiving, by the authorizing entity computer from the central authority computer, a root key and a unique identifier associated with the authorizing entity computer; transmitting, by the authorizing entity computer to a token space computer, a request to setup a new token space; transmitting, by the authorizing entity computer to the central authority computer, the request to set up a new token space comprising parameters of the new token space, wherein the central authority computer verifies the new token space is disjoint from existing token spaces; receiving, by the authorizing entity computer from the central authority computer, a token space operational root key.

The computer readable medium 1208 may comprise several software modules including, but not limited to, a token module 1208A, a token space module 1208B, and a communication module 1208C.

The token module 1208A may comprise code that causes the processor 1202 to manage token-based digital currency. For example, the token module 1208A can comprise code that allows the authorizing entity computer 1200 to issue digital currency accounts for a plurality of users. The token module 1208A may be used to mint and clear tokens.

The token space module 1208B may comprise code that causes the processor 1202 to manage token spaces. For example, the token space module 1208B can comprise code that allows the authorizing entity computer 1200 to establish a token space. The token space module 1208B may be used to create partitions of token spaces.

The communication module 1208C may comprise code that causes the processor 1202 to generate messages, forward messages, reformat messages, and/or otherwise communicate with other entities.

Embodiments of the invention have several advantages. Embodiments of the invention provide for a token-based digital currency system with high consistency, availability, and partition tolerance. Embodiments of the invention provide improvements to combat limitations of distributed systems as described by the CAP theorem. For example, by applying pre-agreed token subspaces, the token-based digital currency system provides an improvement in partition tolerance. Additionally, embodiments of the invention that can use token spaces can allow for users to perform transfer requests offline, while preventing or substantially reducing the chances of double spending. For example, a token space can be set up for tokens that (a) limited to a transaction amount less than $5, (b) limited to a transaction recipient A, and (c) limited to transactions conducted with a certain type of user device such as user device B. Tokens with attributes that satisfy these parameters may be present in the token space, and such tokens can only be used to conduct transactions and cleared once. Since the tokens according to embodiments cannot be cleared twice, the ability for a fraudster to double spend is substantially mitigated or eliminated.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. Aₛ such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

Aₛ used herein, the use of “a,” “an,” or “the” is intended to mean “at least one,” unless specifically indicated to the contrary.

What is claimed is:

1. A method comprising:
generating, by sender device or a sender computer associated with a sender, a base token in a token space associated with parameters, wherein the base token comprises token attributes within the parameters and an amount;
signing, by the sender device or the sender computer, the base token to form a minted token; and
transmitting, by the sender device to a receiver device, a transfer request comprising the minted token.

2. The method of claim 1, wherein the sender computer signs the base token and transmits the minted token to the sender device.

3. The method of claim 1, wherein the sender device signs the base token, and wherein the receiver device modifies a status of the minted token in the token space to generate a cleared token after receiving the minted token.

4. The method of claim 2, wherein the token space is a local token space stored on the receiver device, and wherein the method further comprising:
receiving, by the sender device from the receiver device, a cleared token; and
transmitting, by the sender device to the sender computer, the cleared token.

5. The method of claim 1, wherein the sender computer is authorized to mint and clear tokens in the token space by a central authority computer.

6. The method of claim 1, further comprising:
receiving, by the sender device from the receiver device, a clearing signature; and
transmitting, by the sender device to the sender computer, the clearing signature, wherein the sender computer verifies the clearing signature.

7. The method of claim 1, further comprising:
receiving, by the sender device from the receiver device, a token template comprising at least some of the token attributes.

8. The method of claim 1, wherein after the receiver device receives the minted token, the receiver device performs an integrity check, or an authenticity check on the minted token.

9. The method of claim 1, wherein the token space is an n-dimensional space of n-parameters, wherein the n-parameters include one or more of a sender ID, a receiver ID, a time-to-live, a value, or a device type.

10. The method of claim 1, wherein the base token is signed by the sender computer, and wherein the method further comprises, after signing, by the sender computer, the base token to form the minted token:
transmitting, by the sender computer to an auditing computer, the minted token, wherein the minted token comprises auditing information including one or more of a sender identifier, a receiver identifier, a source ledger address, a destination ledger address, a time stamp, or a clearer identifier.

11. The method of claim 1, wherein the sender device and the receiver device are online.

12. The method of claim 1, the sender computer generates the base token, and debits the amount from a source ledger of the sender.

13. The method of claim 1, wherein the receiver device and the sender device are mobile phones.

14. The method of claim 1, wherein the sender device and the receiver device operate offline and without connection to any other devices or computers.

15. A device comprising:
a processor; and
a non-transitory computer readable medium comprising instructions executable by the processor to perform operations including:
generating a base token in a token space associated with parameters, wherein the base token comprises token attributes with the parameters, and an amount;
signing the base token to form a minted token; and
transmitting, to a receiver device, a transfer request comprising the minted token.

16. A method comprising:
receiving, by a receiver device associated with a receiver from a sender device associated with a sender, a transfer request comprising a minted token in a token space associated with parameters, wherein the minted token comprises token attributes within the parameters;
verifying, by the receiver device, the minted token by checking that token attributes of the minted token are within the parameters of the token space;
modifying, by the receiver device, a status of the minted token to form a modified token; and
signing, by the receiver device, the modified token to form a cleared token.

17. The method of claim 16, wherein the minted token is a token that is signed using a cryptographic key of the sender device or a sender computer associated with the sender.

18. The method of claim 16, wherein modifying the status of the minted token comprises updating a status of the minted token to a cleared status.

19. The method of claim 16, further comprising:
updating, by the receiver device, a destination ledger to include a value in the minted token.

20. The method of claim 16, further comprising:
transmitting, by the receiver device to the sender device, a token template comprising at least some of the token attributes.
